(19) United States
(12) Patent Application Publication
(10) Pub. No.: US 2002/0049791 A1
(43) Pub. Date: Apr. 25, 2002

(54) Method and system for using a personal electronic document for advertising

(75) Inventor: Peilin Chou, Taipei (TW)

Correspondence Address: SONNENSCHEIN NATH & ROSENTHAL, Wacker Drive Station, Sears Tower, P.O. Box #061080, Chicago, IL, 60606-1080, US

(73) Assignee: Bridgewell, Inc.

(21) Appl. No.: 09/902,397

(22) Filed: Jul. 10, 2001

Related U.S. Application Data
(60) Provisional application No. 60/217,298, filed on Jul. 11, 2000.

(51) Int. Cl. G06F 15/00

(52) U.S. Cl. 707/513; 707/515; 707/501.1

(57) ABSTRACT

A method and system for providing an advertisement for a product or service on a personal electronic document accessible over a data network. A carrier provides the product or service to a user. The carrier also provides a document design application to the user. A server in communication with the data network receives the personal electronic document from a first computer in communication with the data network. The personal electronic document is constructed using the document design application. The personal electronic document is associated with the user. The personal electronic document is stored as data on a storage medium in communication with the data network. Advertisement information provided by the carrier is inserted in the personal electronic document. A second computer in communication with the data network is provided access over the data network to the personal electronic document stored on the storage medium. The second computer is associated with a visitor of the personal electronic document.

### REFERENCE TO EARLIER-FILED APPLICATION

This application claims the benefit of U.S. Provisional Application No. 60/217,298, “Method and System for Using a Personal Web Page for Advertising,” filed Jul. 11, 2000.

### BACKGROUND OF THE INVENTION

1. Field of the Invention

The present invention relates generally to advertising over data networks and, in particular, to a method and system for advertising to a visitor of a personal electronic document where that visitor was not previously reached under conventional advertising schemes.

2. Description of the Related Art

The ability to reach consumers using advertising is an important goal of many businesses selling products and services to consumers. Data networks such as the Internet have provided an additional advertising medium for these businesses wishing to reach additional consumers. However, much like traditional print advertising, reaching the target audience that the business wants to reach through the advertisement has been difficult. This is typically because advertisements can only estimate the actual viewing audience that may view the advertisement. Usually only a portion of the actual viewing audience will be interested in the advertisement, and a smaller portion will eventually purchase the product or service. The business is unable to directly communicate the advertisement to all viewers who may be interested in making a purchase. Many of those viewing the advertisement are not within the target audience intended by the business, yet the business pays for the advertising to target and non-targeted individuals. Furthermore, businesses are interested in gathering personal information, i.e., demographics including age, gender, income, hobbies, and other similar information, from consumers in order to more directly target the advertisement.

A need therefore exists for a method and system for advertising to the proper target audience over a data network, such as the Internet, to ensure that advertisements sent by businesses are being received by as many targeted consumers as possible. A further need exists to obtain more personal demographics on consumers that may receive the advertisements over the Internet.

### SUMMARY OF THE INVENTION

One aspect of the present invention relates to a method for providing an advertisement for a product or service on a personal electronic document accessible over a data network. A carrier provides the product or service to a user. The carrier also provides a document design application to the user. A server in communication with the data network receives the personal electronic document from a first computer in communication with the data network. The personal electronic document is constructed using the document design application. The personal electronic document is associated with the user. The personal electronic document is stored as data on a storage medium in communication with the data network. Advertisement information provided by the carrier is inserted in the personal electronic document. A second computer in communication with the data network is provided access over the data network to the personal electronic document stored on the storage medium. The second computer is associated with a visitor of the personal electronic document. Other exemplary methods are provided in accordance with aspects of the present invention.

Another aspect of the present invention relates to a data processing apparatus that performs exemplary methods of the present invention. Yet another aspect of the present invention relates to a system that performs exemplary methods of the present invention. Other aspects of the present invention relate to processor readable storage media and carrier waves providing exemplary methods of the present invention.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a block diagram view of an exemplary embodiment of a system 100 of the present invention;

FIG. 2 is a flowchart showing a method 200 performed in accordance with an exemplary embodiment of the present invention; and

FIG. 3 is a high level block diagram showing an embodiment of a computer system 300 used to implement an exemplary method of the present invention.

### DETAILED DESCRIPTION OF THE PREFERRED EMBODIMENTS

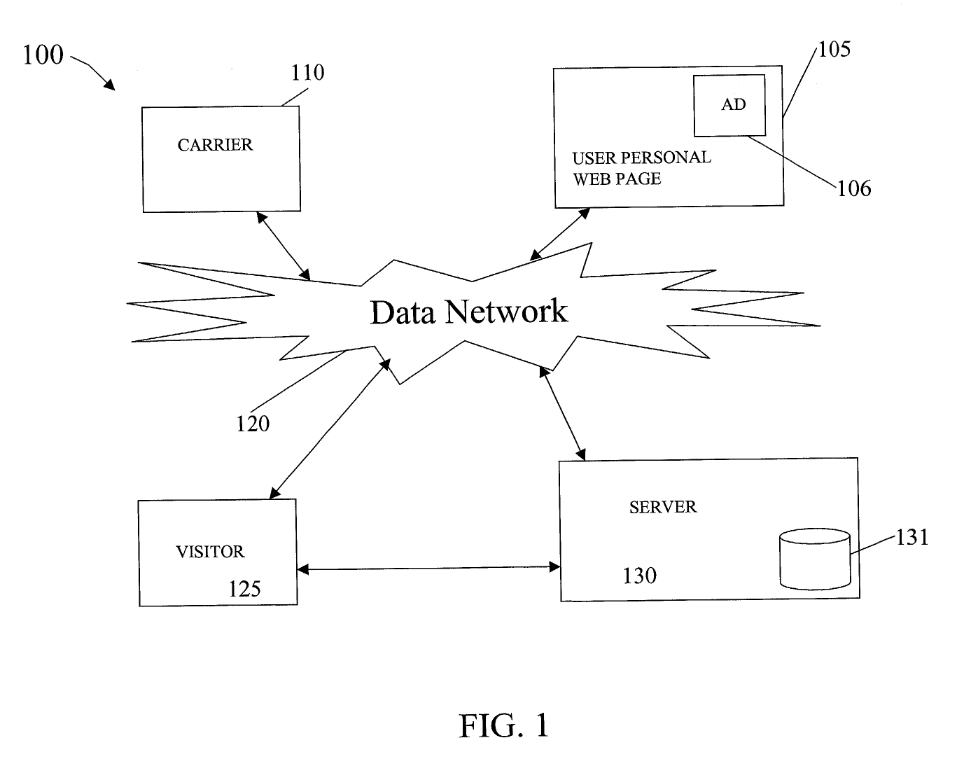

FIG. 1 is a block diagram view of an exemplary embodiment of a system 100 of the present invention. In FIG. 1, a carrier 110 is in communication with a data network 120, such as the Internet or other type of network that permits the exchange of data between the carrier and other modules illustrated in FIG. 1. The carrier 110 is any entity that wishes to put an advertisement 106 on a user personal web page 105. This includes entities that provide both products and services that wish to advertise those products and services. For example, in several embodiments, the carrier may be a computer maker, a digital camera maker, a scanner, or a compact disk title maker. In other alternative embodiments, the carrier is an intermediary that provides the products and services made by the above entities to consumers.

In some embodiments, data network 120 of FIG. 1 is a wide area network (WAN) such as the Internet. Other suitable data networks include frame relay (FR) networks, ATM networks, wide area networks (WAN), and local area networks (LAN). Examples of further suitable networks 120 include satellite transmission, radio broadcasting, cable television broadcasting, direct line-of-site transmission, telecom fiber optic transmission, cellular transmission, wireless transmission, and other networks known to those skilled in the art.

In FIG. 1, the advertisement 106 is placed on user personal web page 105. That is, advertisement information is inserted in the personal web page. Such advertisement information includes, for example, text and/or graphics relating to a product or service. The advertisement information is preferably in the form of digital data that is incorporated into personal web page 105 using a document design application such as a conventional web page design application. In other examples, the advertisement information is simply a URL address or other suitable link to product or service-related information available from a data source (e.g., server, computer, database) in communication with the data network 120.

In FIG. 1, the personal web page 105 is one example of any number of personal electronic documents that are used in exemplary embodiments of the present invention. Other suitable personal electronic documents include word processing documents (e.g., text format, Microsoft Word format, WordPerfect format, etc.), spreadsheet documents (e.g., Excel format), address lists, contact lists, graphics files (e.g., .GIF, .JPG format), and other electronic documents having text and/or graphical data in some format. These electronic documents are “personal” in that the data contained within the documents is personal in nature with respect to a user or users.

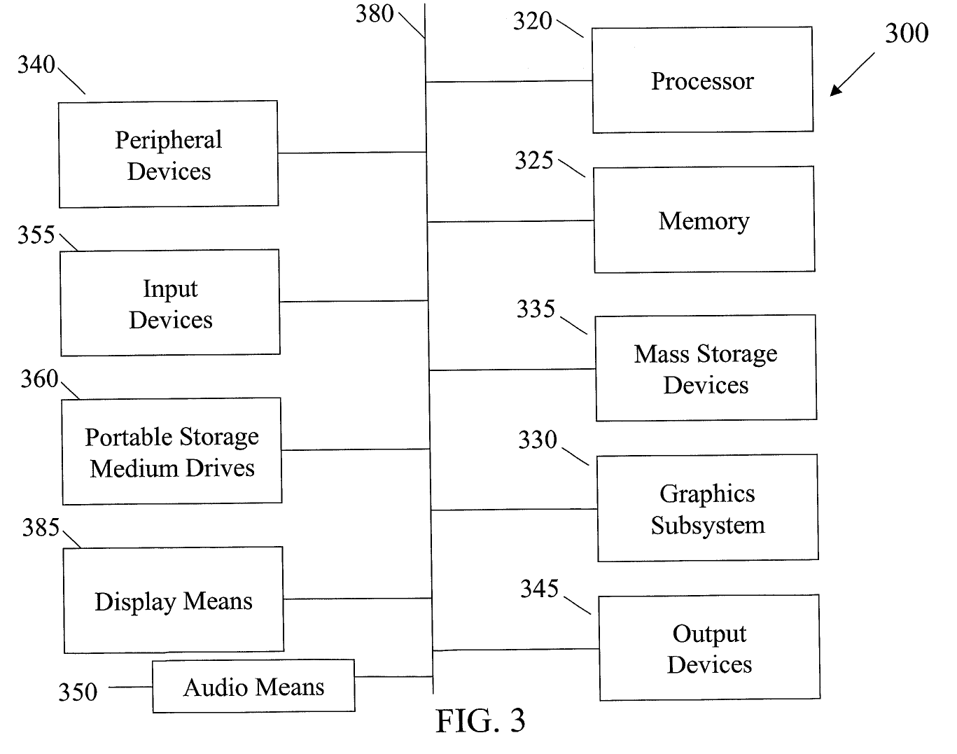

In FIG. 1, the carrier 110 distributes to a user (not shown) a document design application such as a web page software tool (not shown). Other suitable document design applications include conventional software applications that are used to create, edit, and save changes to the personal electronic documents described above. The document design application is used by the user to create personal web page 105 or another personal electronic document on a computer system such as the computer system of FIG. 3 below.

Preferably, the advertisement is for the product or service purchased by the user. The user therefore has experience with the product or service being shown in advertisement 106 on the user personal web page 105. The visitor 125 may therefore rely on the user's experience with the product or service to accept, reject, discuss or obtain more information regarding the advertisement 106 for the product or services. Thus, the carrier 110 will be reaching a visitor 125 of the “broadcast channel advertisement” that, in the prior advertising scheme, was not possible.

Personal web pages are known in the industry, as well as advertisements or banners. With conventional advertisements schemes, however, visitors that visit a user personal web page generally have no connection with the user. With exemplary methods and systems of the present invention, a visitor is often familiar with the user and, hence, the user's personal web page. Often, the visitor has a personal reason to visit the user personal web page 105. A user typically informs the visitor 125 that the user personal web page 105 is available and instructs the visitor to visit the user personal web page 105. The visitor then views the advertisement 106 by the carrier 110 and may direct questions to the user related to the product or service advertised.

In FIG. 1, a server 130 in the system 100 is, in one embodiment, a computer system such as the computer system 300 of FIG. 3 below. Other commercially available servers are used in other exemplary embodiments, as will be understood by the skilled artisan. In FIG. 1, the server 130 is in communication with a storage medium 131, for example, a database. The storage medium is any type of storage device, including the memory 325, mass storage devices 335, and portable storage medium drives 360 of FIG. 3. The storage medium is coupled within the server 130, in some embodiments, and coupled external to the server 130 in other embodiments. The storage medium 131 is in communication with the data network 120. In some embodiments, the storage medium 131 is directly accessible via the data network 120, while in other embodiments, the storage medium 131 is indirectly accessible via the server 130.

In FIG. 1, the storage medium 131 receives and stores the personal electronic document. In other exemplary embodiments, the personal electronic document is stored on a different storage medium accessible over the data network 120. The storage medium 131 is further able to receive information from the user when the user registers (when setting up the personal web page). That is, when creating the personal web page, the user registers by sending personal information concerning the demographics of the user including age, gender, income and all other information that generally describes the user which is sent to the database 131 of the server 130 over the data network 120. The personal information in the storage medium 131 may be retrieved, sold, or otherwise used in order to target advertising to particular individuals.

In use, carrier 110, for example, a computer maker, sells a computer to a user (not shown) Along with the computer, the user receives a CD-ROM containing a web page software tool which enables a user to create a user personal web page 105. In this way, carrier 110 physically distributes the personal web page software tool to the user with the product or service that the carrier 110 has sold to the user. The user thereafter gains experience with the product and/or service of carrier 110. After designing the personal web page 105 using the web page software tool, the user informs visitors of the existence of the user personal web page. These visitors, who generally are colleagues of the user, visit the user personal web page as a result of their personal relationship with the user. The carrier 110 broadcasts an advertisement on the personal web page so that visitor 125 of the user personal web page 105 may view the advertisement 106. This aspect is where a practical application in the technological arts is shown. That is, the visitor 125 generally has a personal relationship with the user 105 and therefore may obtain more information from the user concerning the product or service being advertised in the advertisement 106, since the user has experience with that product or service being advertised. Thus, unlike prior art advertising schemes, carrier 110 may directly advertise through a broadcast channel to a visitor 125 where the broadcast channel is the advertisement 106 broadcasting the product or services of the carrier 110, to visitors of the user personal web page 105.

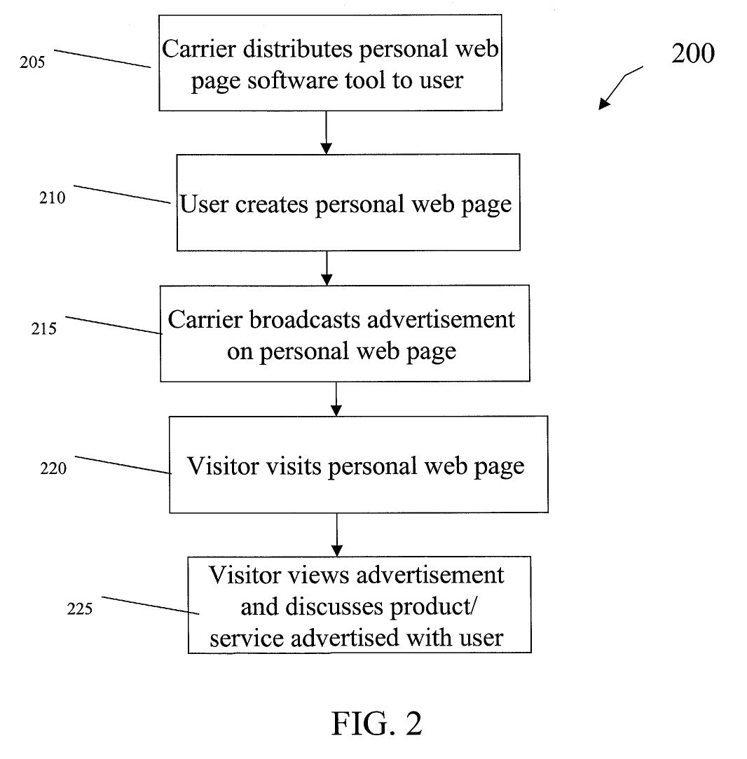

FIG. 2 is a flowchart showing a method 200 performed in accordance with an exemplary embodiment of the present invention. In step 205, the carrier 110 of FIG. 1 generally distributes the document design application to the user. In one exemplary embodiment, the carrier 110 bundles the document design application with services or products sold by the carrier 110 to the user. For example, the document design application is stored on a processor readable storage medium and physically delivered to the user with a purchased product. In another exemplary embodiment, the document design application is provided as an electronic signal and sent to a computer accessible by the user over the data network. In some embodiments, the product or service is in electronic form, such as a software application, and sent as a signal over the data network to the user with the document design application. In an alternative exemplary embodiment, the carrier 110 rents advertising space from the user on the user's personal electronic document after the user has purchased the product or service from the carrier.

In FIG. 2, the user creates a personal web page at step 210, and the carrier broadcasts an advertisement on the personal web page at step 215. When a visitor visits the personal web page through the Internet at step 220, the visitor can then view the advertisement and discuss the product or service advertised with the user at step 225. Again, a useful application of the technological arts of the method shown in FIG. 2 is that a visitor of the personal web page visits the user's personal web page through a personal relationship with the user. Thus, by viewing the advertisement of a carrier of a product or service that a user purchased or used of the carrier, the carrier is able to focus its advertisement to a visitor who has the personal relationship with the user. Thus, the advertisement is directed to a visitor who often has similar interests with an individual who purchased or used a product or service of the carrier. The visitor may ask the user about the product or service of the carrier being advertised.

A still further advantage of exemplary methods and systems of the present invention is that the user's information, upon registration and storage in a database, is able to be used by advertisers (carriers) since it contains direct information concerning the user's demographics that include hobbies, interests, age, gender and the like. Thus, the exemplary methods and systems of the present invention contain numerous advantages over prior advertising schemes.

FIG. 3 is a high level block diagram view of a computer system 300 used to implement an embodiment of the method of the present invention. The terms “computer,” “computer system,” “server,” and “data processing apparatus” are used interchangeably herein and, therefore, the system 300 of FIG. 3 is intended to illustrate exemplary embodiments of all of these respective devices. The general purpose computer 300, in one embodiment, acts as the server 130 of FIG. 1. In another embodiment, the user personal web page is retrieved using the computer system 300 of FIG. 3. Likewise, the visitor can access the user personal web page with the computer system of FIG. 3.

In FIG. 3, the computer system 300 includes a processor 320 for executing program instructions stored in a memory 325. In some embodiments, processor 320 includes a single microprocessor, while in others, processor 320 includes a plurality of microprocessors to define a multi-processor system.

In FIG. 3, the memory 325 stores instructions and data for execution by processor 320, including instructions and data for performing the methods described above. Depending upon the extent of software implementation in computer system 300, the memory 325 stores executable code when in operation. The memory 325 includes, for example, banks of read-only memory (ROM), dynamic random access memory (DRAM), as well as high-speed cache memory.

In FIG. 3, within computer system 300, an operating system comprises program instruction sequences that provide a platform for the methods described above. The operating system provides a software platform upon which application programs may execute, in a manner readily understood by those skilled in the art. The data computer system 300 further comprises one or more applications having program instruction sequences for performing the methods described above.

In FIG. 3, the computer system 300 incorporates any combination of additional devices. These include, but are not limited to, a mass storage device 335, one or more peripheral devices 340, an audio means 350, one or more input devices 355, one or more portable storage medium drives 360, a graphics subsystem 330, a display means 385, and one or more output devices 345.

In FIG. 3, the various components are connected via an appropriate bus 380 as known by those skilled in the art. In alternative embodiments, the components are connected through other communications media known in the art. For purposes of simplicity, the components shown in FIG. 3 are depicted as being connected via a single bus 380 (i.e. transmitting means). However, the components may be connected through one or more data transport means (e.g. Internet, Intranet, etc.). In one example, processor 320 and memory 325 are connected via a local microprocessor bus; while mass storage device 335, peripheral devices 340, portable storage medium drives 360, and graphics subsystem 330 are connected via one or more input/output (“I/O”) buses.

In FIG. 3, mass storage device 335 is implemented as fixed and/or removable media, for example, as a magnetic, optical, or magneto-optical disk drive. The drive is preferably a non-volatile storage device for storing data and instructions for use by processor 320. In some embodiments, mass storage device 335 stores client and server information, code for carrying out methods in accordance with exemplary embodiments of the invention, and computer instructions for processor 320. In other embodiments, computer instructions for performing methods in accordance with exemplary embodiments of the invention also are stored in processor 320. The computer instructions are programmed in a suitable language such as Java or C++.

In FIG. 3, the portable storage medium drive 360, in some embodiments, operates in conjunction with a portable non-volatile storage medium, such as a floppy disk, CD-ROM, or other computer-readable medium, to input and output data and code to and from the computer system 300. In some embodiments, methods performed in accordance with exemplary embodiments of the invention are implemented using computer instructions that are stored on such a portable medium and input to the data processing apparatus 300 via portable storage medium drive 360.

In FIG. 3, the peripheral devices 340 include any type of computer support device, such as an I/O interface, to add functionality to data processing apparatus 300. In one example, the peripheral devices include a network interface card for interfacing the data processing apparatus 300 to a network, a modem, and the like. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry.

In FIG. 3, the graphics subsystem 330 and the display means 385 provide output alternatives of the system. The graphics subsystem 330 and display means 385 include conventional circuitry for operating upon and outputting data to be displayed, where such circuitry preferably includes a graphics processor, a frame buffer, and display driving circuitry. The display means 385 may include a cathode ray tube (CRT) display, a liquid crystal display (LCD), or other suitable devices. The display means 385 preferably can display at least 256 colors. The graphics subsystem 330 receives textual and graphical information and processes the information for output to the display means 385. A video card in the data processing apparatus 300 also comprises a part of graphics subsystem 330 and also preferably supports at least 256 colors. For optimal results in viewing digital images, the user should use a video card and monitor that can display the True Color (24 bit color) setting. This setting enables the user to view digital images with photographic image quality.

In FIG. 3, audio means 350 preferably includes a sound card, on-board sound processing hardware, or a device with built-in processing devices that attach via Universal Serial Bus (USB) or IEEE 1394 (Firewire). The audio means 350 receives audio signals from a peripheral microphone. In addition, audio means 350 may include a processor for processing sound. The signals can be processed by the processor in audio means 350 of data processing apparatus 300 and passed to other devices as, for example, streaming audio signals.

The devices contained in the computer system of FIG. 3 are those typically found in general purpose computers, and are intended to represent a broad category of such computer components that are well known in the art. The system of FIG. 3 illustrates one platform which can be used for practically implementing the method of the present invention. Numerous other platforms can also suffice, such as Macintosh-based platforms available from Apple Computer, Inc., platforms with different bus configurations, networked platforms, multi-processor platforms, other personal computers, workstations, mainframes, navigation systems, and the like.

In some embodiments, programs for performing methods in accordance with exemplary embodiments of the invention are delivered as computer program products. These generally include a processor readable storage medium or media having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMS, magnetic or optical cards, hard disk, flash card, smart card, and other media.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain other embodiments, a program for performing an exemplary method of the invention or an aspect thereof is situated on a carrier wave such as an electronic signal transferred over a data network. Suitable networks include a frame relay network, an ATM network, a wide area network (WAN) such as the Internet, or a local area network (LAN). In one embodiment, the method of the present invention is implemented in computer instructions and those computer instructions are transmitted in an electronic signal through cable, satellite or other transmitting means for transmitting the computer instructions in the electronic signals. Those skilled in the art will recognize that merely transferring the program over the network, rather than executing the program on a computer system or other device, does not avoid the scope of the invention.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems and user applications. Ultimately, such computer readable media further includes software for performing the method of the present invention as described above.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method for providing an advertisement for a product or service on a personal electronic document accessible over a data network, the method comprising:
providing, by a carrier, the product or service to a user;
providing, by the carrier, a document design application to the user;
receiving over the data network, by a server in communication with the data network, the personal electronic document from a first computer in communication with the data network, the personal electronic document constructed using the document design application, the personal electronic document associated with the user;
storing the personal electronic document as data on a storage medium in communication with the data network;
inserting, in the personal electronic document, advertisement information provided by the carrier; and
providing access over the data network to the personal electronic document stored on the storage medium by a second computer in communication with the data network, the second computer associated with a visitor of the personal electronic document.

2. The method of claim 1 wherein the data network is an Internet.

3. The method of claim 1 wherein the advertisement information describes the product or service.

4. The method of claim 1, providing the document design application to the user including sending the document design application as an electronic signal over the data network from the server to the first computer.

5. The method of claim 1, providing the product or service and the document design application to the user including sending the product or service and the document design application as an electronic signal over the data network from the server to the first computer.

6. The method of claim 1, the document design application stored on a processor readable storage medium.

7. The method of claim 1 further comprising:
receiving over the data network, by the server, personal information for the user from the first computer.

8. The method of claim 7 further comprising:
storing, by the server, the personal information on the storage medium.

9. The method of claim 7 wherein the personal information includes demographics data.

10. The method of claim 9 wherein the demographics data is age data.

11. The method of claim 9 wherein the demographics data is gender data.

12. The method of claim 9 wherein the demographics data is income data.

13. A method for advertising over a data network for a product or service on a personal web page, the method comprising:
providing the product or service to a user as a part of a purchase of the product or service by the user, the product or service provided by a carrier;
providing a web page design application to the user, the web page design application provided by the carrier;
receiving over the data network, by a server in communication with the data network, the personal web page from a first computer in communication with the data network, the personal web page constructed using the web page design application, the personal web page associated with the user;
storing the personal web page as data on a storage medium in communication with the data network;
embedding, in the personal web page, advertisement information associated with the carrier; and
providing access over the data network, by a second computer in communication with the data network, to the personal web page stored on the storage medium, the second computer associated with a visitor of the personal web page, the visitor having a relationship with the user.

14. The method of claim 13 further comprising:
receiving over the data network, by the server, personal information associated with the user.

15. The method of claim 14 further comprising:
storing, by the server, the personal information on the storage medium.

16. The method of claim 14 wherein the personal information includes demographics data.

17. The method of claim 16 wherein the demographics data is age data.

18. The method of claim 16 wherein the demographics data is gender data.

19. The method of claim 16 wherein the demographics data is income data.

20. A method for advertising over an Internet for a product or service on a personal web page accessible via the Internet, the method comprising:
providing the product or service to a user as a first part of a purchase of the product or service by the user, the product or service provided by a carrier;
providing a web page design application to the user as a second part of the purchase of the product or service by the user, the web page design application provided by the carrier;
receiving over the Internet, by a server in communication with the Internet, the personal web page from a first computer in communication with the Internet, the personal web page constructed using the web page design application and associated with the user;
storing the personal web page as data on a storage medium in communication with the data network;
embedding, in the personal web page, advertisement information associated with the carrier; and
providing access over the Internet, by a second computer in communication with the Internet, to the personal web page stored on the storage medium, the second computer associated with a visitor of the personal web page, the visitor having a relationship with the user.

21. A processor readable storage medium having processor readable program code that, when executed by a processor in a data processing apparatus, performs a method for providing an advertisement for a product or service on a personal electronic document accessible over a data network, the method comprising:
providing, by a carrier, the product or service to a user;
providing, by the carrier, a document design application to the user;
receiving over the data network, by a server in communication with the data network, the personal electronic document from a first computer in communication with the data network, the personal electronic document constructed using the document design application, the personal electronic document associated with the user;
storing the personal electronic document as data on a storage medium in communication with the data network;
inserting, in the personal electronic document, advertisement information provided by the carrier; and
providing access over the data network to the personal electronic document stored on the storage medium by a second computer in communication with the data network, the second computer associated with a visitor of the personal electronic document.

22. The processor readable storage medium of claim 21 wherein the advertisement information describes the product or service.

23. The processor readable storage medium of claim 21, providing the document design application to the user including sending the document design application as an electronic signal over the data network from the server to the first computer.

24. The processor readable storage medium of claim 21, providing the product or service and the document design application to the user including sending the product or service and the document design application as an electronic signal over the data network from the server to the first computer.

25. A carrier wave having processor readable program code executable by a processor in a data processing apparatus to perform a method for providing an advertisement for a product or service on a personal electronic document accessible over a data network, the method comprising:
providing, by a carrier, the product or service to a user;
providing, by the carrier, a document design application to the user;
receiving over the data network, by a server in communication with the data network, the personal electronic document from a first computer in communication with the data network, the personal electronic document constructed using the document design application, the personal electronic document associated with the user;
storing the personal electronic document as data on a storage medium in communication with the data network;
inserting, in the personal electronic document, advertisement information provided by the carrier; and
providing access over the data network to the personal electronic document stored on the storage medium by a second computer in communication with the data network, the second computer associated with a visitor of the personal electronic document.

26. The carrier wave of claim 25 wherein the advertisement information describes the product or service.

27. The carrier wave of claim 25, providing the document design application to the user including sending the document design application as an electronic signal over the data network from the server to the first computer.

28. The carrier wave of claim 25, providing the product or service and the document design application to the user including sending the product or service and the document design application as an electronic signal over the data network from the server to the first computer.

29. A data processing apparatus for providing an advertisement for a product or service on a personal electronic document accessible over a data network, the product or service provided by a carrier, the data processing apparatus in communication with the data network, the data processing apparatus comprising:
a memory in which a plurality of instructions are stored; and
a processor coupled to the memory and capable of executing the instructions in the memory, execution of the instructions causing a plurality of steps to be performed including storing a personal electronic document as data on a storage medium in communication with the data network, the storing being responsive to receiving over the data network, by a server in communication with the data network, the personal electronic document from a first computer in communication with the data network, the personal electronic document constructed using a document design application, the personal electronic document associated with the user;
advertisement information provided by the carrier being inserted in the personal electronic document; and
the personal electronic document stored on the storage medium being accessible over the data network by a second computer in communication with the data network, the second computer associated with a visitor of the personal electronic document.

30. The data processing apparatus of claim 29 wherein the data processing apparatus is a server.

31. The data processing apparatus of claim 29 wherein the advertisement information describes the product or service.
